(19) United States
(12) Patent Application Publication
(10) Pub. No.: US 2011/0006898 A1
(43) Pub. Date: Jan. 13, 2011

(54) SYSTEMS AND METHODS FOR PREVENTION OF THEFT OF LED LIGHT BULBS

(75) Inventors: James Robert Kruest, San Diego, CA (US); Paul Atkinson, Poway, CA (US)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: AEQUITAS Innovation, Poway, CA (US)

(21) Appl. No.: 12/832,704

(22) Filed: Jul. 8, 2010

Related U.S. Application Data
(60) Provisional application No. 61/223,706, filed on Jul. 8, 2009.

(51) Int. Cl. G08B 13/14; H01Q 1/24

(52) U.S. Cl. 340/568.1; 343/702

(57) ABSTRACT

A merchandise control device is described that can be attached to a light emitting diode (“LED”) light bulb. A radio frequency identification (“RFID”) circuit located within the LED light bulb is configured to respond to an interrogating radio frequency (RF) signal at a point of sale. An antenna provided on an external surface of the LED light bulb, or on a sheet attached to the LED light bulb, has an electrical connection that communicates the RF signal to the RFID device. The RFID device is configured to enable function of the LED light bulb upon receiving a security code from the RF signal that matches a security code stored in the RFID device.

### CROSS-REFERENCE TO RELATED APPLICATIONS

The present Application claims priority from U.S. Provisional Patent Application No. 61/223,706 filed Jul. 8, 2009, which is expressly incorporated by reference herein.

### BACKGROUND OF THE INVENTION

1. Field of the Invention

The present invention relates generally to security systems for controlling commercial merchandise.

2. Description of Related Art

LED light bulbs are a component of a lighting system. The LEDs comprising an LED light bulb operate at low DC voltages, typically 12 volts or 24 volts. Therefore the standard 120-240 VAC used throughout the world must be converted and conditioned using electronic circuits suitably designed for such purposes. Such power supplies, regulators and LED driver circuits are common in the industry. These electronic circuits in and of themselves contain no processors or logic control devices, and are present in the LED light bulb only for the purpose of providing consistent and optimal voltage and current to the LEDs. Often though the basic circuits can be adapted to allow for some degree of external control. For example, a buck regulator circuit (National Semiconductor LM2842) which provides the stabilized voltage to the LED driver circuit uses a Shutdown input pin to enable or disable the regulator. This feature of the regulator can be used to control the utility of the LED light. For instance, a receiver may be incorporated into the light bulb capable of receiving signals over the power line, such as with Broadband over Power Lines (BPL) technology. The receiver in turn may provide a degree of control over the Shutdown input of that regulator. Infrared or other wireless communication may be incorporated into the design of the LED light bulb affording a degree of remotely control over the operation of the LED light bulb. However, each of these methods requires that power be available to the light bulb through its fixture, and that the voltage be present during the time of communication so that the respective receivers and control circuits may function. Further, the LED light bulb itself has no individual power on/off switch; all of the bulbs circuitry is energized only when affixed into its socket and the socket itself has power applied.

Conventional systems incorporate the antenna for an RFID used to control electronic circuits directly onto the printed circuit board of the item, as it is generally convenient to do so. In the case of LED light bulbs, the circuit board is generally too small and it is difficult to implement a suitable antenna for UHF frequencies. Furthermore the circuit board is typically concealed within the metallic base of the bulb, shielding the RF and impeding communication. Needed is a novel approach to integrating the antenna element of the wireless technology into the item.

### BRIEF SUMMARY OF THE INVENTION

The above described limitations and other limitations of the prior art are overcome in LED light bulbs constructed according to certain aspects of the invention. In particular, the invention described herein facilitates the construction of an antenna having suitable efficiency for use with LED light bulbs by properly sizing the antenna for an RFID and providing the antenna in a location that is clear of the RF shielding effects of surrounding materials.

Certain embodiments of the invention provide systems and methods for protecting light bulbs from the threat of theft. With the emphasis on moving toward energy-saving “green” lighting technology, there have been advances in the development of cost-effective LED lighting. LED lighting products are being developed for residential, commercial and industrial applications, both design-in and direct replacements for standard incandescent bulbs. LED bulbs consume less power usage and last longer than standard bulbs, and so command high prices which make them attractive targets for thieves.

The incentive for thieves to steal LED light bulbs can be removed if the utility of the bulb (e.g. its ability to light) is denied thieves. Of particular interest are systems and methods where the utility of the bulb is locked by the manufacturer and wirelessly unlocked at the point of sale. In certain embodiments, an LED light bulb can be wirelessly unlocked at the point-of-sale (POS) when the bulb is not powered (e.g. plugged into a socket).

### BRIEF DESCRIPTION OF THE DRAWINGS

FIG. 1 is a schematic of a wireless transceiver interface to LED controls according to certain aspects of the invention.

FIG. 2 is an image of an LED light bulb tagged using an RFID according to certain aspects of the invention.

FIG. 3 is a line drawing identifying various elements of an LED light bulb constructed according to certain aspects of the invention.

FIG. 4 is a line drawing showing connections between antenna and an internal RFID of an LED light bulb constructed according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention provide systems and methods that facilitate the incorporation of RFID technology into LED light bulbs. Certain embodiments employ wireless technology and RFIDs to enable and disable electronic circuits. These systems and methods resolve many of the problems known to exist with prior art systems, particularly where applied to certain types of products, such as LED light bulb replacements for incandescent lighting, where the construction of a suitable antenna has heretofore proven to be problematic.

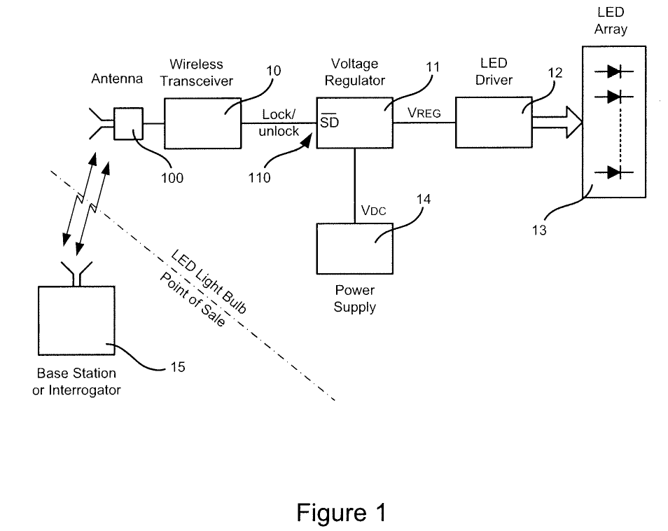

In certain embodiments, an LED light bulb is enhanced with a wireless transceiver capable of receiving and transmitting information and data while the LED bulb is in an unpowered state, for instance, while the bulb is still within a retail package. With reference to FIG. 1, a wireless transceiver 10 can be a “passive” device, deriving its power from the incident RF field, but it can also be an “active” device containing its own power supply (not shown), typically comprising some combination of a battery, a capacitor, a photovoltaic cell, etc. The wireless transceiver 10 comprises a “front end” portion capable of transceiving data communications in addition to harvesting power from incident energy sources, such as a radio frequency field or optical radiation. In certain embodiments, the front end comprises an antenna 100. In conventional systems, antenna 100 is provided on a substrate that carries the RFID transceiver circuit. The wireless transceiver 10 also comprises a “back end” interface capable of controlling an aspect of electronic circuitry 11, 12, 14 associated with the LED light bulb 13. In one example, a shut down pin 110 of regulator circuit 11 can be controlled.

With reference also to FIG. 3, the wireless transceiver 10 is typically provided in a location proximate to the LED light bulb's electronic circuits and may be advantageously located within the sealed bulb 31 or its base 33 where it cannot be circumvented by thieves without damaging the bulb.

In certain embodiments, the wireless transceiver 10 can be further enhanced with security features in the form of access control passwords or keys. Configured with these enhancements the LED light bulb can be manufactured and placed into an inoperative or “locked” state. The light bulb remains in this locked state through the supply chain and onto store shelves, and is therefore not attractive to thieves and hence less likely to be stolen.

During the check-out process at a point of sale (“POS”), a wireless communication is initiated between the POS system 15 and the protected product. This communication exchange typically comprises an exchange of identification data and passwords or “keys” and if the pre-established security criteria are met, the transaction authorizes the product to “unlock.” Once unlocked, the product will operate normally for its intended application. Various security schemes may be employed to obtain a desired level of security. In one example, the transaction process may be configured to operate with a “null” password or key where the higher level of security afforded by using a password is not required. In another example, and exchange of information may be required to ensure that the user of the POS is authorized to unlock the merchandise.

In the locked state, the wireless transceiver 10 interface provides a disabling signal to an electronic circuit 11, 12 or 14 of the light bulb. In one example, a “logic low” signal to the Shutdown input 110 of voltage regulator 11 effectively disables the operation of the light bulb. When authorized by the POS transaction, the interface signal changes to for instance a “logic high” signal allowing regulator 11 to operate normally, thereby “unlocking” the product. The phase of the logic signal may be inverted to accommodate other techniques used for enabling or disabling one of the electronic circuits 11-14. For example, an FET may be used to drive the control pin 110 of regulator 11. In certain embodiments, a memory register associated with the wireless transceiver is set during the locking or unlocking transaction to indicate the state of the locking device, and can be queried by the POS system to confirm that the unlocking event has succeeded. In some embodiments, the merchandise can be locked after unlocking as needed, for example, to facilitate return and restocking of the LED light bulb.

In one example of an embodiment according to certain aspects of the invention, the wireless transceiver comprises a form of an RFID chip, and communicates by RF operating in the range of 900 MHz (UHF) utilizing industry standard protocols such as ISO-18000C, also referred to as EPC Gen 2 RFID standard. Utilizing the EPC Gen 2 standard facilitates adoption among retailers who are also using this RFID standard for supply chain logistics and item level RFID tracking. In another example of an embodiment according to certain aspects of the invention, the wireless transceiver communicates by RF operating in the range of 13.56 MHz (HF) and using ISO-14443 used in Near Field Communications (NFC), or ISO-15693 industry standards.

The antenna 100 for the wireless transceiver may be incorporated into the design and layout of the LED light bulb substrate and/or circuit board. When such an embodiment is mounted within the LED light bulb, the materials for the light's housing must be at least partially transparent to the wireless communication frequency used (e.g. UHF) and/or the RFID may be located to obtain a suitable signal strength.

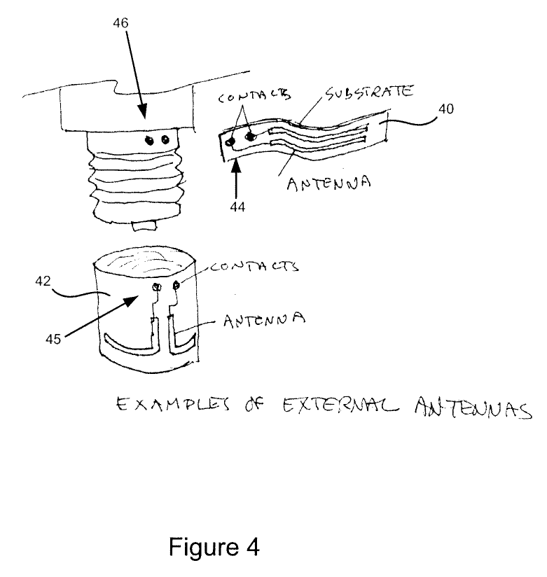

In certain embodiments, antenna 100 is provided separately from, but connected to the RFID transceiver 10. With reference to FIG. 4, antenna 100 may be permanently or temporarily electrically connected to the transceiver 10. Antenna 100 may reside on an external surface of the light bulb and/or on a temporary or permanent tab, tag, sleeve or other elements attached to the light bulb. Antenna 100 typically cooperates with a transceiver component 10 located within the bulb through an electrical connection that may include the bulb's electrical power connectors and/or special contacts and wiring provided and appropriately located for such purpose.

In one example, an antenna element may be provided on a paper element by printing an antenna using a conductive ink and/or an etched or deposited metallic trace. The antenna element is fit onto the bulb's base, where it may be held in place by friction or by threading. The antenna element can effect electrical contact between antenna terminations and the electrical contacts of the bulb's base. The antenna element may make contact with additional contacts provided on the bulb's base, where the additional contacts are specially included to interface with the antenna terminations. The antenna may be provided on a “free floating” substrate, attached only at its contact points. Once connected, the antenna element enables RF communication to be conducted from the antenna to the RFID chip located within the base of the bulb.

An external antenna 100 may be etched or printed using conductive inks on a disposable substrate 40, such as paper or plastic. An external antenna 100 may be formed on a sleeve 42 that encircles the threaded end of the light bulb. The substrate 40 and/or sleeve 42 can be held in place by friction and aligned so that the antenna contacts 44 or 45 align with the contacts 46 provided on the light bulb. The light bulb is typically unlocked at the point of sale, after which the customer may at his convenience remove and discard the antenna element 40 or 42.

An antenna can utilize metal material of the light bulb's base. The metal material may be a heat sink element for cooling the electronics, an as aesthetic element and/or mechanical support for the globe of the light bulb. Metal elements may include an element in the form of ribs or stripes that can comprise all or part of an antenna. Metal elements may include an element having a slot formed in a metal plane that can comprise a suitable slot-type antenna. The metal antenna elements are typically positioned advantageously to allow electrical contact with the internal circuit board and RFID chip. With this type of antenna, the antenna typically remains permanently attached to and/or integral with the light bulb, and so can allow follow-on communication with the RFID chip and any data stored on the chip.

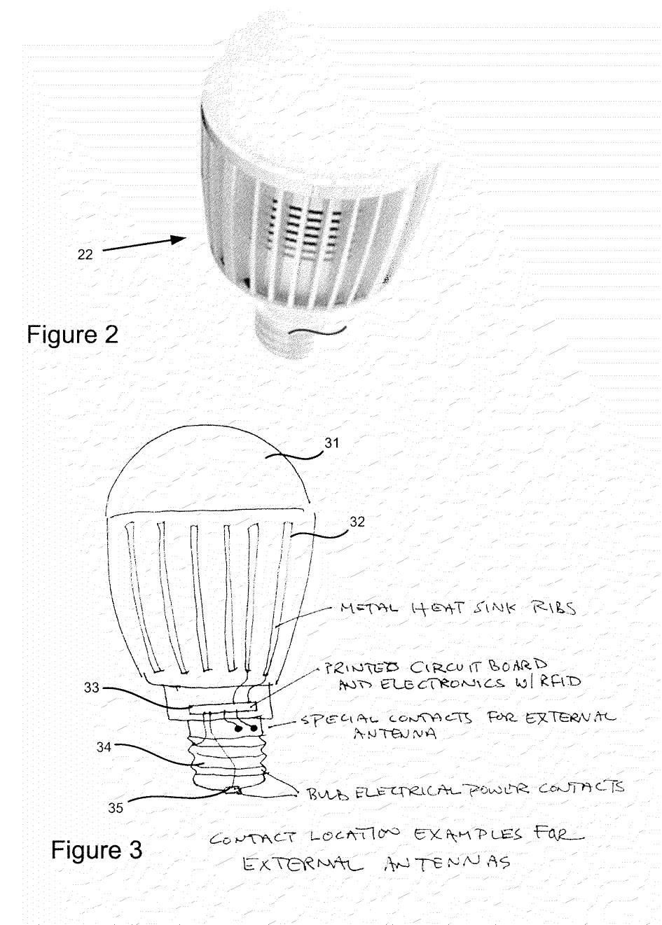

With reference also to FIGS. 2 and 3, in certain embodiments, a heat sink portion 22 is often incorporated into the LED light bulb and is typically made, at least partially, from metallic elements. These metallic elements may be used as part of the antenna 100 shown in FIG. 1. Metallic elements may include ribs 32 that can be used in an antenna. An antenna may be formed by creating a slot or other discontinuity in the ribs 32. An antenna can be printed, etched or deposited on the ribs or on a paper, plastic or other suitable substrate material attached or embedded in a surface of the light bulb. Connection with RFID transceiver 10 may be made through wires provided for the purpose. The antenna substrate may be adhered to the glass or plastic globe 31 of the LED light bulb.

In certain embodiments, a wireless transceiver chip is employed that incorporates a unique identification number so that each LED light bulb so equipped can be uniquely identified and individually locked or unlocked from a single remote location using an RF transmitter. Additional memory associated with the wireless transceiver may be utilized to store information specific to the manufacturer, the bulb itself, (e.g. UPC code, model number, manufacturing or expiration date etc.), retailer, or other as may be deemed useful.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide a merchandise control device attached to a light emitting diode (“LED”) light bulb. Some of these embodiments comprise a radio frequency identification (“RFID”) circuit or device located within the LED light bulb. In some of these embodiments, the RFID circuit is configured to respond to an interrogating radio frequency (RF) signal at a point of sale. Some of these embodiments comprise an antenna provided on a surface external to the LED light bulb. Some of these embodiments comprise an electrical connection that communicates the RF signal to the RFID device. In some of these embodiments, the RFID device is configured to enable function of the LED light bulb upon receiving a security code from the RF signal that matches a security code stored in the RFID device.

In some of these embodiments, the RF signal includes a control signal. In some of these embodiments, the RFID device is configured to enable function of the LED light bulb when the control signal has a first value. In some of these embodiments, the RFID device is configured to disable function of the LED light bulb when the control signal has a second value. In some of these embodiments, the security code comprises a key. In some of these embodiments, the security code further comprises an identifier encrypted using a key stored by the RFID device. In some of these embodiments, the security code includes a password. In some of these embodiments, the RFID maintains identifying information corresponding to the LED light bulb and, the RFID is configured to provide the identifying information responsive to the RF signal.

Some of these embodiments comprise a substrate externally mounted on a base of the LED light bulb. In some of these embodiments, the antenna is formed on the substrate. In some of these embodiments, the substrate is removed when the LED light bulb is inserted in a light bulb socket. In some of these embodiments, the substrate is formed as a sheet and comprises one or more of paper, plastic and Mylar. In some of these embodiments, the substrate encircles the base. In some of these embodiments, the substrate is free floating and attached to the base by the electrical connection.

In some of these embodiments, the antenna is formed on a metallic surface of the LED light bulb. In some of these embodiments, the antenna is formed on a heat sink. In some of these embodiments, the antenna is formed on an aesthetic feature of the LED light bulb. In some of these embodiments, the antenna is formed as a dipole. In some of these embodiments, the antenna is formed as a patch type antenna. In some of these embodiments, the antenna is a slot type antenna.

In some of these embodiments, the antenna comprises a dipole. In some of these embodiments, the antenna comprises a patch type antenna. In some of these embodiments, the antenna comprises a slot type antenna. In some of these embodiments, the electrical connection includes the power connections for the LED light bulb. In some of these embodiments, the power connection provides power at 50 volts or more.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A merchandise control device attached to a light emitting diode (“LED”) light bulb, comprising:
a radio frequency identification (“RFID”) circuit located within the LED light bulb and configured to respond to an interrogating radio frequency (RF) signal at a point of sale;
an antenna provided on a surface external to the LED light bulb; and
an electrical connection that communicates the RF signal to the RFID circuit,
wherein the RFID circuit is configured to enable function of the LED light bulb upon receiving a security code from the RF signal that matches a security code stored in the circuit device.

2. The device of claim 1, wherein the RF signal includes a control signal and wherein the RFID circuit is configured to enable function of the LED light bulb when the control signal has a first value the RFID circuit is configured to disable function of the LED light bulb when the control signal has a second value.

3. The device of claim 1, wherein the security code comprises a key.

4. The device of claim 1, wherein the security code further comprises an identifier encrypted using a key stored by the RFID circuit.

5. The device of claim 1, wherein the security code includes a password.

6. The device of claim 1, wherein the RFID circuit maintains identifying information corresponding to the LED light bulb and, the RFID circuit is configured to provide the identifying information responsive to the RF signal.

7. The device of claim 1, further comprising a substrate externally mounted on a base of the LED light bulb, wherein the antenna is formed on the substrate, and wherein the substrate is removed when the LED light bulb is inserted in a light bulb socket.

8. The device of claim 7, wherein the substrate is formed as a sheet and comprises one or more of paper, plastic and Mylar.

9. The device of claim 8, wherein the substrate encircles the base.

10. The device of claim 8, wherein the substrate is free floating and attached to the base by the electrical connection.

11. The device of claim 1, wherein the antenna is formed on a metallic surface of the LED light bulb.

12. The device of claim 11, wherein the antenna is formed on a heat sink.

13. The device of claim 11, wherein the antenna is formed on an aesthetic feature of the LED light bulb.

14. The device of claim 11, wherein the antenna comprises a dipole.

15. The device of claim 11, wherein the antenna comprises a patch type antenna.

16. The device of claim 11, wherein the antenna comprises a slot type antenna.

17. The device of claim 11, wherein the electrical connection includes the power connections for the LED light bulb.
